(19) United States
(12) Patent Application Publication
(10) Pub. No.: US 2015/0040071 A1
(43) Pub. Date: Feb. 5, 2015

(54) DISPLAYING SCHEDULE ITEMS ON A DEVICE

(71) Applicant: International Business Machines Corporation, Armonk, NY (US)

(72) Inventors: Tomoka Mochizuki, Sumida-ku (JP); Tomonori Sugiura, Kanagawa (JP); Wen Lianzi, Kanagawa (JP)

(21) Appl. No.: 14/296,714

(22) Filed: Jun. 5, 2014

(30) Foreign Application Priority Data
Jul. 30, 2013 (JP) 2013-157500

(51) Int. Cl. G06F 3/0482; G06F 3/0484

(52) U.S. Cl. CPC G06F 3/0482; G06F 3/04842
USPC 715/844

(57) ABSTRACT

In one embodiment, a device includes a collection unit, an estimation unit, and a display control unit. The collection unit is configured to collect a record of a process operated on a computer by a user. The estimation unit is configured to estimate a time slot when the process is to be activated, based on the collected record. The display control unit is configured to change, by a computer processor, a display mode of a display item for activating the process according to the estimated time slot, on a screen of the computer.

### PRIORITY

This application claims priority to Japanese Application No. 2013-157500, filed Jul. 30, 2013, and all the benefits accruing therefrom under 35 U.S.C. §119, the contents of which in its entirety are herein incorporated by reference.

### BACKGROUND

The present invention relates generally to managing a schedule on a computing device and, more particularly, to displaying items within that schedule.

A device capable of managing the schedule of a user is known. One example of such a device is described in Japanese Pub. JP2005-275833A.

### SUMMARY

In one embodiment, a device includes a collection unit, an estimation unit, and a display control unit. The collection unit is configured to collect a record of a process operated on a computer by a user. The estimation unit is configured to estimate a time slot when the process is to be activated, based on the collected record. The display control unit is configured to change, by a computer processor, a display mode of a display item for activating the process according to the estimated time slot, on a screen of the computer.

In another embodiment, a computer-implemented method includes collecting a record of a process operated on a computer by a user. A time slot is estimated for when the process is to be activated, based on the collected record. A display mode of a display item, for activating the process according to the estimated time slot, is changed on a screen of the computer.

In yet another embodiment, a computer program product for displaying a schedule item includes a computer readable storage medium having program instructions embodied therewith. The program instructions are executable by a processor to cause the processor to perform a method. The method includes collecting a record of a process operated on a computer by a user. Further according to the method, a time slot is estimated for when the process is to be activated, based on the collected record. A display mode of a display item, for activating the process according to the estimated time slot, is changed on a screen of the computer.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is an overall configuration diagram of a device according to some embodiments;

FIG. 2 is an example of a record database of processes collected and generated by a collection unit, according to some embodiments;

FIG. 3 is an example of a time slot database estimated and generated by an estimation unit, according to some embodiments;

FIG. 4 is a screen of a display unit displaying display items in an unchanged display mode, according to some embodiments;

FIG. 5 is the screen of the display unit displaying display items in a changed display mode, according to some embodiments;

FIG. 6 is a flow chart of a generation process of the record database by the collection unit, according to some embodiments;

FIG. 7 is a flow chart of a generation process of the time slot database by the estimation unit, according to some embodiments;

FIG. 8 is a flow chart of a process of changing the display mode by the display control unit and the estimation unit, according to some embodiments;

FIG. 9 is the screen of the display unit where display in another changed display mode is performed, according to some embodiments;

FIG. 10 is the screen of the display unit where display in yet another changed display mode is performed, according to some embodiments;

FIG. 11 is the screen of the display unit where display in yet another changed display mode is performed, according to some embodiments; and

FIG. 12 is an example of a hardware configuration of a computer according to some embodiments.

### DETAILED DESCRIPTION

Hereinafter, the present invention will be described with reference to embodiments of the invention, but the embodiments below are not intended to limit the scope of the claims. Also, all the combinations of the features described in the embodiments are not necessarily essential to the invention.

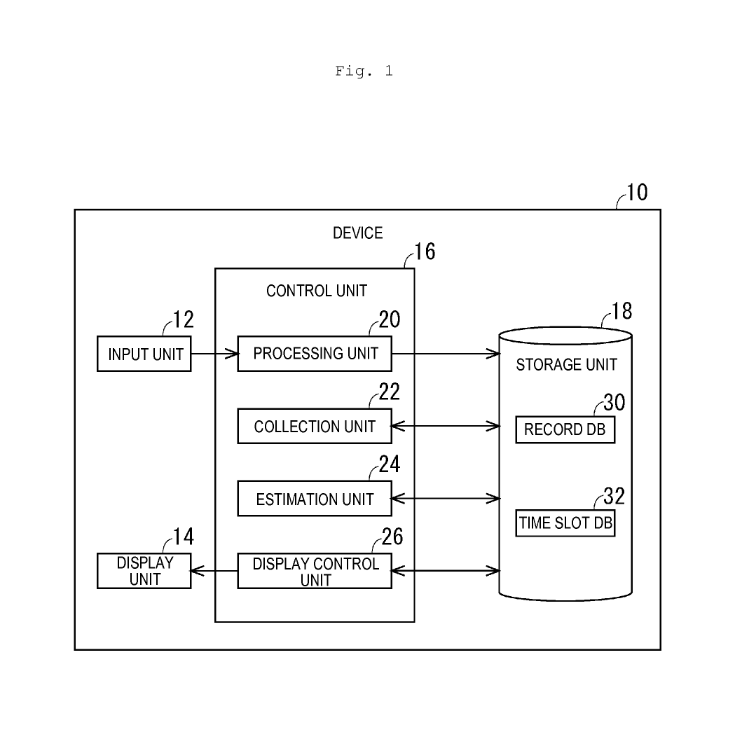

FIG. 1 is an overall configuration diagram of a device 10 according to some embodiments. The device 10 is, for example, a computer capable of activating a process such as an application or a file. The device 10 estimates a time slot when a process is to be activated from the record of the process. The device 10 changes a display mode of a display item for activating the process in the estimated time slot. The device 10 thereby allows a user to easily notice the display item for the process and reduces the burden of the user for activating the process.

In some embodiments, the device 10 includes an input unit 12, a display unit 14, a control unit 16, and a storage unit 18.

The input unit 12 is connected to the control unit 16. The input unit 12 may be implemented by at least one of a keyboard, a mouse, a touch panel and the like. The input unit 12 receives an input from a user and outputs the input to the control unit 16.

The display unit 14 is connected to the control unit 16. The display unit 14 may be a liquid crystal display device, an organic EL display device or the like. The display unit 14 receives image information from the control unit 16 and displays an image including at least one of text, a mark, a pattern and the like based on the image information. For example, the display unit 14 displays an icon including a shortcut or the like as a display item for activating a process.

The control unit 16 controls the device 10 in an overall manner. The control unit 16 is, for example, an arithmetic control device such as a CPU (Central Processing Unit). The control unit 16 includes or functions as a processing unit 20, a collection unit 22, an estimation unit 24, and a display control unit 26. In some embodiments, the control unit 16 may function as the processing unit 20, the collection unit 22, the estimation unit 24, and the display control unit 26 by reading programs stored in the storage unit 18. Alternatively, at least one of the processing unit 20, the collection unit 22, the estimation unit 24, and the display control unit 26 may be configured by hardware such as a circuit.

The processing unit 20 is connected to the input unit 12 and the storage unit 18. The processing unit 20 receives an input from a user through the input unit 12 and, in response, activates and performs a process. The process includes, or is initiated by way of, an application, a file, or the like. Additionally, a file includes data that is activated by an application such as word processor software, spreadsheet software, or the like. By operating a display item associated with the file, the application is activated, and the contents of the file are read. Moreover, the process may be initiated through a web page on the Internet. When an input of a user received through the input unit 12 is interpreted as selection of a display item displayed on the display unit 14, the processing unit 20 activates the process that is associated with the display item. The processing unit 20 stores an activation time and an end time of the process that is operated in the storage unit 18 as a process table.

Furthermore, the processing unit 20 acquires schedule information of a user from a network or the input unit 12, and stores the schedule information in the storage unit 18. The schedule information is stored by a calendar application or the like, for example. The schedule information includes an entry indicating the specifics of a schedule such as a regular meeting or the like, and a start time and a completion time of the schedule. The entry includes a schedule ID set in advance so as to allow identification of a schedule, and a schedule name, which is the name of the schedule.

The collection unit 22 is connected to the storage unit 18. The collection unit 22 collects a record of a process operated by a user on the device 10, from the process table in the storage unit 18. The record of a process is, for example, an activation time of the process stored in the storage unit 18. The record of a process may also include an entry of the schedule. The collection unit 22 stores the record of a process collected at the estimation unit 24 in the storage unit 18 in a record database 30.

The estimation unit 24 is connected to the storage unit 18. The estimation unit 24 estimates the time slot when a process is to be performed, based on the record collected by the collection unit 22. The estimation unit 24 stores the estimated time slot in the storage unit 18 in association with the process in a time slot database 32.

The display control unit 26 is connected to the storage unit 18 and the display unit 14. The display control unit 26 changes the display mode of a display item DS for activating a process, on the screen of the display unit 14 of the device 10 (e.g., on the desktop of an interface), according to the time slot estimated by the estimation unit 24 and stored in the storage unit 18. For example, the display control unit 26 changes the display mode of a display item DS for a process by highlighting the display item DS in such a way that the display item DS is, for example, enlarged on the screen of the display unit 14 in a time slot when the process is estimated to be performed.

The storage unit 18, or schedule storage unit, stores programs, as well as data for controlling the device 10. For example, the programs stored in the storage unit 18 are executed by the control unit 16 and cause the control unit 16 to function as the processing unit 20, the collection unit 22, the estimation unit 24, and the display control unit 26. For example, the storage unit 18 may store data such as the schedule information of a user, the record database 30, the time slot database 32, and the like.

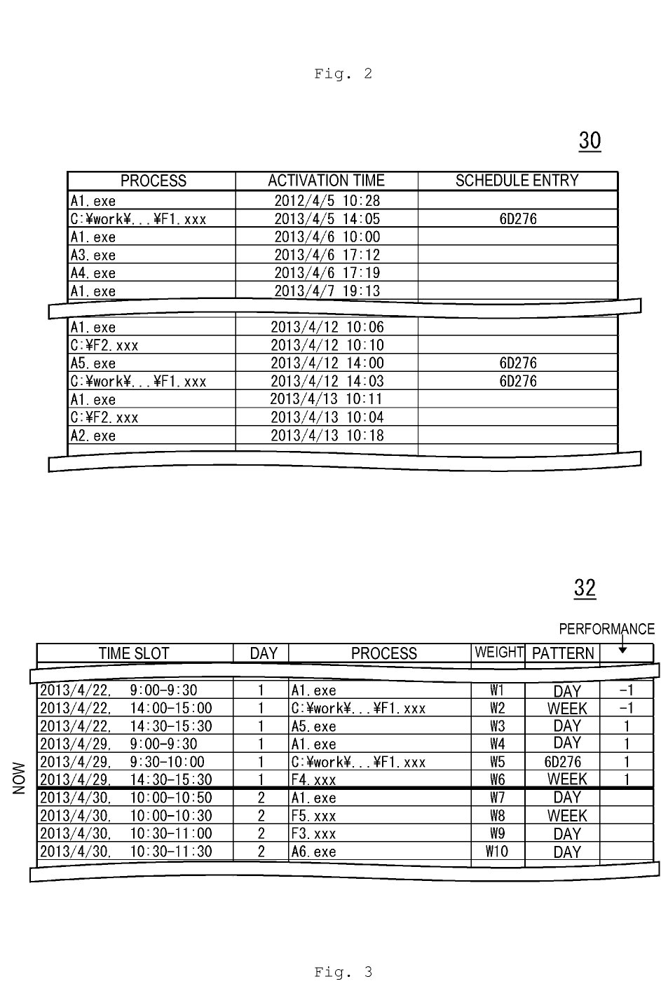

FIG. 2 is an example of the record database 30 of processes collected and generated by the collection unit 22, according to some embodiments. The collection unit 22 stores in the storage unit 18 as the record database 30 records of a process such as an application, a file, or the like; an activation time; and an entry of a schedule in association with one another.

Specifically, the collection unit 22 collects a process, such as an application, a file, or the like activated by the processing unit 20, from the process table in the storage unit 18. Additionally, in some embodiments, the collection unit 22 desirably collects only the process that is activated by the processing unit 20 according to an instruction of a user. Whether the activation is according to an instruction of a user or not may be determined by the collection unit 22 based on a flag for activation determination. The processing unit 20 stored that flag in association with the process in the process table based on the user's instruction. In other words, the collection unit 22 need not collect processes that the processing unit 20 activated without instructions from a user.

The collection unit 22 registers the file name of a collected process in the record database 30. Further, in the case the process is a file, the collection unit 22 registers in the record database 30 a file name including a full path of a storage destination. In the case the process is an application, the collection unit 22 instead registers only the application name of the process in the record database 30. Additionally, description will be given taking, for example, Fn.xxx as the file name in the case the process is a file, and An.exe as the file name in the case the process is an application, as shown in FIG. 2, where n=1, 2, 3, etc.

The collection unit 22 collects, from the storage unit 18 an activation time including the date and time of activation of a collected process. The collection unit 22 registers the collected activation time in the record database 30 in association with the process.

The collection unit 22 searches among pieces of schedule information in the storage unit 18 for the schedule information corresponding to the activation time. For example, if a schedule carried out at 10:28 AM on Apr. 5, 2013, which is the activation time of an application A1.exe, is not found, the collection unit 22 need not store the entry of the schedule in the record database 30. On the other hand, for example, if the entry of the schedule carried out on 2:05 PM on Apr. 5, 2013, which is the activation time of a file F1.xxx, is found, the collection unit 22 may register the entry “6D276” that has been found in the record database 30 in association with the process. Additionally, if entries of a plurality of schedules have been found, the collection unit 22 registers the plurality of entries in association with the process.

FIG. 3 is an example of the time slot database 32 estimated and generated by the estimation unit 24, according to some embodiments. Additionally, as shown by “now” in FIG. 3, a case where the current time is before 9:00 AM on Apr. 30, 2013 is described as an example.

The estimation unit 24 regularly estimates a time slot when a process is to be activated, where the estimation is based on the record database 30 collected by the collection unit 22, and generates the time slot database 32 as shown in FIG. 3. For example, the estimation unit 24 estimates a time slot every day. The estimation unit 24 stores the time slot databases 32, thereby associating an estimated time slot, day of the week, process, weight, pattern, and performance with one another in the storage unit 18.

The estimation unit 24 registers in the time slot database 32 a time slot when a target process is estimated to be activated. Additionally, the time slot is the time when the display control unit 26 changes the display mode of a display item DS. For example, the estimation unit 24 estimates the time slot when a process is to be activated based on a plurality of activation times of the process stored in the record database 30. Also, the estimation unit 24 estimates the time slot of a process to be used with respect to each schedule, according to the entry of the schedule and the time from the start time to the completion time of the schedule included in the schedule information.

The estimation unit 24 registers in the time slot database 32 a numerical value data indicating a day of the week, such as Monday, as the day of the week. For example, Monday is represented by “1”, and Tuesday by “2”. Additionally, the estimation unit 24 may also use text data as the day of the week, instead of the numerical value data, and may register “Mon” for Monday and “Tue” for Tuesday, for example.

The estimation unit 24 registers the file name of a process whose time slot has been estimated in the time slot database 32.

The estimation unit 24 registers a weight in the time slot database 32 for determining whether to change the display mode of the display item DS for the process. The estimation unit 24 increases or decreases the weight by performance, as described below. For example, the estimation unit 24 calculates the weight based on the equation “weight=number of times a process is activated+sum of performances”. In some embodiments, the estimation unit 24 registers a process in the time slot database 32 when the weight is equal to or greater than a weight threshold. The weight threshold is five to ten activation times, for example. The display control unit 26 then changes the display mode of a process registered in the time slot database 32.

The estimation unit 24 registers in the time slot database 32 the pattern of activation of a process. The estimation unit 24 registers “day”, “week”, “month”, entry, and the like as the pattern of activation for, respectively, activation that occurs daily, weekly, monthly, and the like. The display control unit 26 changes in a time slot that is registered the display mode of a process for which “day” is registered as the pattern every day. The display control unit 26 changes the display mode of a process for which “week” is registered as the pattern every week, where the change is made in a time slot on the day of the week that is registered. The display control unit 26 changes the display mode of a process for which “month” is registered as the pattern every month, where the change is made in a time slot on the same day of the month that is registered. The display control unit 26 changes the display mode of a process for which an entry is registered as the pattern, where the change is made in a time slot when the schedule of the entry is to be carried out.

The estimation unit 24 registers in the time slot database 32 a value as the performance, indicating whether the process is activated in the time slot. For example, if the process is activated in the time slot, the estimation unit 24 registers “1” as the performance. For further example, if the process is not activated in the time slot, the estimation unit 24 registers “−1” as the performance. Accordingly, in the case of calculating the weight, the estimation unit 24 increments the weight by “1” if the process is activated in the time slot and decrements the weight by “1” if the process is not activated in the time slot.

FIG. 4 is a screen of the display unit 14 displaying display items in an unchanged display mode, according to some embodiments. The display control unit 26 displays the display items DS at the same size on the display unit 14 while there is no process in the time slot estimated by the estimation unit 24. The display control unit 26 displays, together with icons indicating the processes, the names of the processes on the display unit 14 as the display items DS.

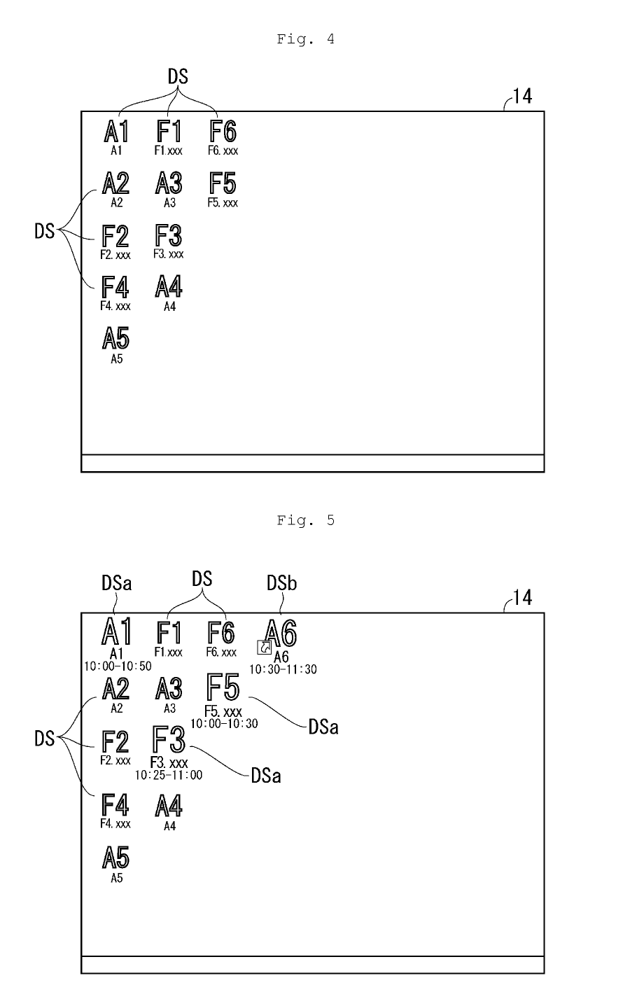

FIG. 5 is the screen of the display unit 14 displaying display items in a changed display mode, according to some embodiments. During the time slot registered in the time slot database 32, the display control unit 26 changes the display mode of the display item DS of a process associated with the time slot. For example, if the application A1.exe is registered in the time slot database 32, the display control unit 26 enlarges a display item DSa of the application A1.exe during the time slot from 10 AM to 10:50 AM on Apr. 30, 2013, and displays the same on the display unit 14 in the changed display mode. Additionally, the display mode of the enlarged display item DSa is an example of a highlighted display.

The display control unit 26 may change the name of the process included in the display item DSa by adding letters or the like. For example, the display control unit 26 may achieve a display mode where the name of the process is changed, by associating information indicating the estimated time slot with the display item DSa. Further, the display control unit 26 may achieve a display mode where the name of the process is changed, by adding a name to the time slot. In some cases, if the display item is not displayed on the screen (for example, in a case a process such as a file is present not on the screen but in a lower level of a file hierarchy), the display control unit 26 displays, on the screen of the display unit 14, a shortcut for the process as a display item DSb in the estimated time slot. For example, the display control unit 26 displays the display item DSb for an application A6.exe, which is not displayed in the state in FIG. 4, on the display unit 14 while enlarging the same only during the time slot.

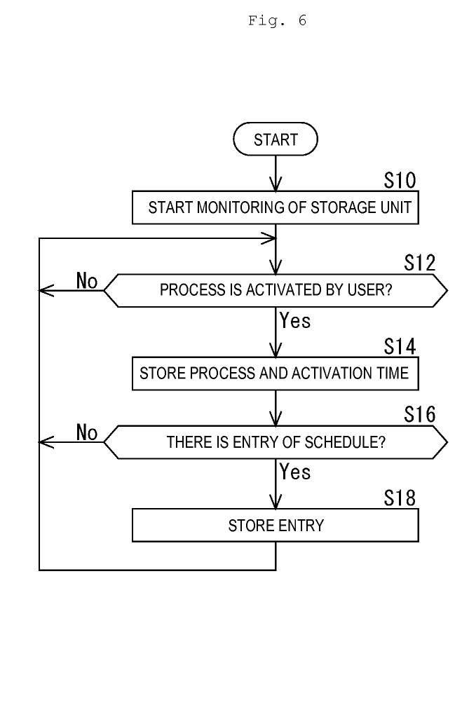

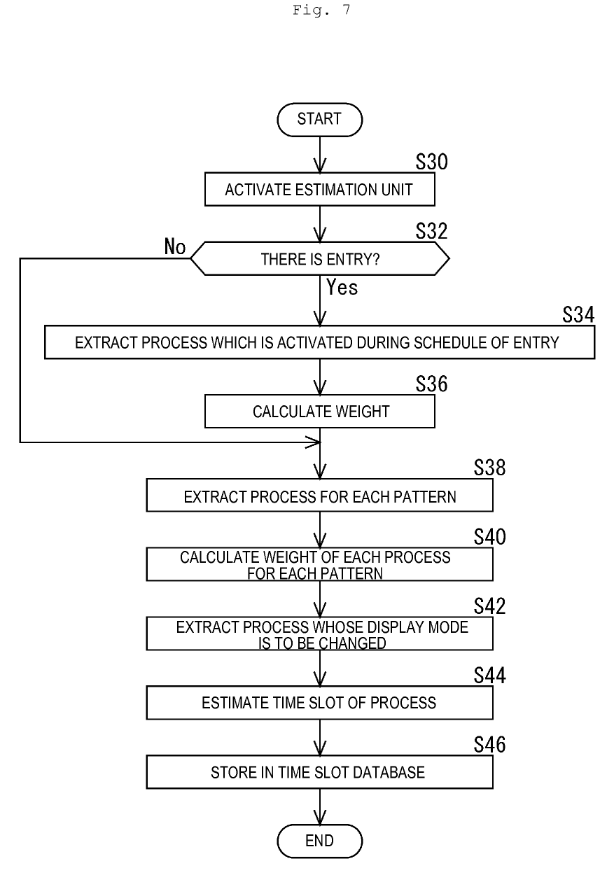

FIG. 6 is a flow chart of a generation method of the record database 30 by the collection unit 22, according to some embodiments.

In a generation method of the record database 30, the collection unit 22 starts monitoring of the storage unit 18 to determine whether a new process is activated by a user (S10). The collection unit 22 determines whether a process is activated by a user, based on the monitoring result (S12). In the case a process is not activated by a user, the collection unit 22 remains a wait state until a process is activated (S12: No). The collection unit 22 determines that a process is activated by a user, when a process activated by the user and the activation time are newly stored by the processing unit 20 in the storage unit 18 (S12: Yes). When a process is determined to have been activated, the collection unit 22 stores the activation time of the process in the record database 30 of the storage unit 18 in association with the process that has been activated (S14).

The collection unit 22 determines whether there is an entry of a schedule at the activation time of the process (S16). For example, if the activation time is within a time period when a schedule is being carried out (i.e., a time period between a start time to a completion time of a schedule), the collection unit 22 determines that there is an entry of a schedule (S16: Yes), and stores the process in the record database 30 and the entry of the schedule information in association with each other (S18). On the other hand, if the activation time is not within a time period when a schedule is being carried out, the collection unit 22 determines that there is no entry of a schedule (S16: No). Thereafter, the collection unit 22 updates and generates the record database 30 by repeating blocks S12 to S18 regularly or as appropriate.

FIG. 7 is a flow chart of a generation method of the time slot database 32 by the estimation unit 24, according to some embodiments. The generation method of the time slot database 32 may be performed regularly, for example, at the same time every day.

In the generation method of the time slot database 32, the estimation unit 24 is activated (S30). Then, the estimation unit 24 determines, based on the schedule information in the storage unit 18, whether there is an entry of a schedule in a predetermined extracted period from the present to future (S32). The extracted period is two days including “today” and “tomorrow”, for example. In this case, the estimation unit 24 determines presence/absence of an entry for today and tomorrow. If it is determined that there is an entry (S32: Yes), the estimation unit 24 extracts a process from the record database 30 (S34), where the extracted process was activated while the same schedule was being carried out in a past estimation period. The estimation period for a schedule determined in advance is several days, half a year, one year, or the like, for example. Additionally, the estimation unit 24 determines whether the schedules are the same, based on the entries. Also, if it is determined that there are a plurality of entries, the estimation unit 24 extracts a process that was activated during the schedule of each entry. After calculating the weight of each extracted process (S36), the estimation unit 24 performs block S38. On the other hand, if it is determined that there is no entry (S32: No), the estimation unit 24 performs block S38 without performing blocks S34 and S36.

The estimation unit 24 then extracts processes for patterns “day”, “week” and “month” based on the activation times (S38). The estimation unit 24 refers to the activation time, and extracts a process that is activated daily or nearly daily for the pattern “day”. For example, the estimation unit 24 determines as “day” the pattern of a process that is activated on a number of days that is equal to or greater than a pattern threshold. Specifically, for further example, if the pattern threshold is 80%, the estimation unit 24 determines that the pattern of a process that is activated on 80% or more of the days is “day”. For example, the estimation unit 24 searches for the activation of a process across ten days, and determines the pattern of a process that is activated on eight or more days as “day”. In the similar manner, the estimation unit 24 refers to the activation time, and extracts a process that is activated weekly (or nearly weekly) or monthly (or nearly monthly) for the patterns “week” and “month” respectively. Moreover, with respect to a process whose pattern is determined to be “week”, the estimation unit 24 also determines on which day of every week activation takes place. Furthermore, with respect to a process whose pattern is determined to be “month”, the estimation unit 24 may also determine on which day of every month activation takes place.

The estimation unit 24 calculates the weight of each process extracted for each pattern of “day”, “week”, and “month” (S40). The estimation unit 24 compares the weight of each process whose weight has been calculated with the weight threshold, and extracts a process whose weight is equal to or greater than the weight threshold as the process whose display mode is to be changed (S42). The estimation unit 24 estimates and sets the time slot when the display mode of the extracted process is to be changed (S44).

If a specific process is activated almost daily, weekly or monthly in a time span determined in advance, the estimation unit 24 estimates a time period including at least a part of the activation time of the process as the time slot.

For example, the estimation unit 24 extracts, from the record database 30, the activation time of a process activated in an estimation period determined in advance. The estimation period determined in advance is several days, half a year, one year, or the like, for example. Additionally, the estimation period may be set on a per-pattern basis. For example, in the case the pattern is “day”, the estimation period is set to 50 days. Similarly, for another example, in the case the pattern is “week” or “month”, the estimation period is set to 50 weeks or 50 months.

For example, the estimation unit 24 extracts the activation time of the application A1.exe, shown in FIG. 2, in the estimation period determined in advance, from the record database 30. The activation time of the application A1.exe is from 10 AM to 07:13 PM. Then, the estimation unit 24 selects out an activation time within an interval threshold determined in advance. The interval threshold is one hour, for example. In this case, the estimation unit 24 selects out, among the activation times which have been extracted, 10 AM to 10:28 AM, which are included in the interval threshold (that is, within one hour), as the activation times. Here, the estimation unit 24 performs estimation while dividing the time slot in units of 30 minutes, for example. Accordingly, of the activation times that have been selected out, the estimation unit 24 estimates the same time as the first activation time or the closest time, at 0- or 30-minute marks, before the first activation time as the start of the time slot. Also, of the activation times that have been selected out, the estimation unit 24 estimates the same time as the last activation time or the closest time, at 0- or 30-minute marks, later than the last activation time as the end of the time slot. Accordingly, the estimation unit 24 estimates, based on the activation times which have been selected out, 10 AM to 10:30 AM as the time slot of the application A1.exe.

Furthermore, if a process is activated in the past schedule, the estimation unit 24 estimates the planned time of the schedule (i.e., from the start time to the completion time) as the time slot when the process is to be activated. For example, if the schedule is that shown in FIG. 2, where a file F1.xxx is activated and the entry is “6D276” is carried out from 09:30 AM to 10 AM, the estimation unit 24 estimates 09:30 AM to 10 AM as the time slot.

The estimation unit 24 stores the process whose display mode is to be changed, the time slot, the weight, and the pattern in the time slot database 32 in the storage unit 18 (S46). Additionally, in some embodiments, the estimation unit 24 arranges the processes in order from the earliest start time to the latest in the time slot.

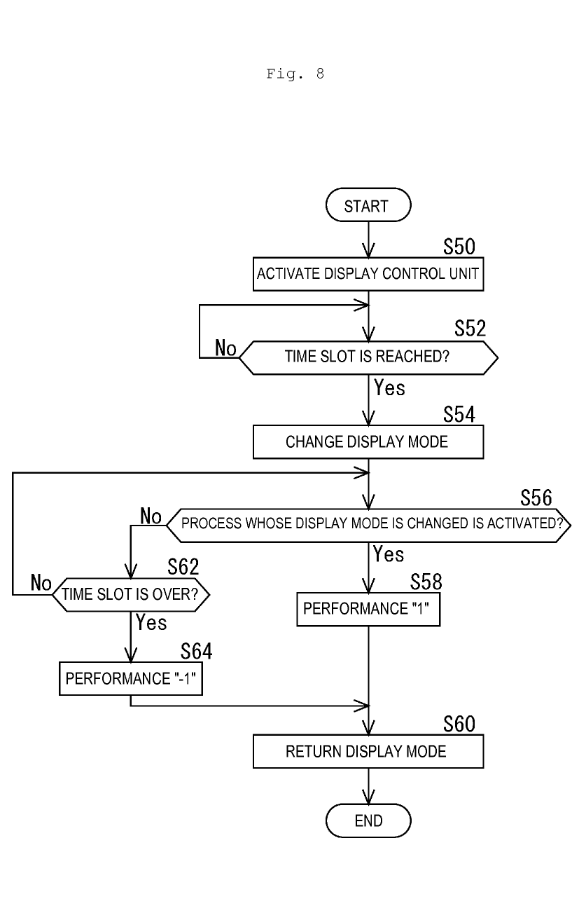

FIG. 8 is a flow chart of a method of changing the display mode by the display control unit 26 and the estimation unit 24, according to some embodiments. The flow chart of the method of changing the display mode is performed for each display item whose display mode is to be changed.

In the process of changing the display mode, the display control unit 26 is activated (S50). The display control unit 26 refers to the time slot database 32 and determines whether the current time is in a time slot of a process (S52). If it is determined that a time slot of a process is reached (S52: Yes), the display control unit 26 changes the display mode of a display item DSa for the process (S54). The display control unit 26 determines whether the process of the display item DSa whose display mode has been changed is activated (S56). Here, if the process is activated by the user, the processing unit 20 stores the activation time in the storage unit 18 in association with the process. The estimation unit 24 refers to the storage unit 18, and if the activation time of the process is determined to be within the time slot, the estimation unit 24 determines that the process whose display mode has been changed is activated (S56: Yes), and stores “1” for the performance in the time slot database 32 (S58). When the process is activated, the display control unit 26 returns the display mode of the display item of the process that was changed for activation to the original display mode (S60). Additionally, the original display mode includes ending display of a display item that was not displayed before the time slot.

On the other hand, if the process whose display mode has been changed is determined to be not activated (S56: No), the display control unit 26 determines whether the time slot is over (S62). The display control unit 26 repeatedly performs block S56 until the time slot is determined to be over (S62: No). If it is determined that the time slot is over without the process whose display mode has been changed being activated (S62: Yes), the display control unit 26 stores “−1” as the performance (S64). Then, the display control unit 26 returns the display mode that has been changed to the original mode (S60).

As described above, with the device 10, the estimation unit 24 estimates the time slot when a process is to be activated, based on the record database 30 of processes collected by the collection unit 22. When a time slot is reached, the display control unit 26 changes the display mode of the display item DSa for a process associated with the time slot. The device 10 thereby reduces the burden on a user regarding activation of a process and allows the user to easily activate the process. Particularly, the display control unit 26 enlarges, and displays in a highlighted manner, a display item DSa whose time slot is reached, and thus, a user is enabled to easily recognize the display item DSa.

The display control unit 26 displays a display item for a process in a lower level of a file hierarchy, which is not displayed on the display unit 14, on the display unit 14 when the time slot is reached. The device 10 may thereby reduce the time it takes for a user to find the display item for a process in a lower level.

When the process of the display item DSa whose display mode is changed is activated within the time slot, the display control unit 26 returns the display item DSa to the original display mode. The device 10 may thereby relatively emphasize the display item for a process whose display mode is changed but which is not yet activated.

As described above, with respect to a process activated by an entry of the same schedule, the estimation unit 24 estimates the time slot based on the entry. Accordingly, even if the schedule is changed, the estimation unit 24 may estimate the time slot according to the changed schedule. Accordingly, even if a schedule that is carried out regularly every week is changed to be carried out on a different day of the week for a certain week, the display control unit 26 may change the display mode according to the schedule.

The connection relationship of the elements, the display mode, the numerical values such as the number of pieces, the enlargement rate, and the like of each embodiment described above may be changed as appropriate. Also, the embodiments may be combined as appropriate.

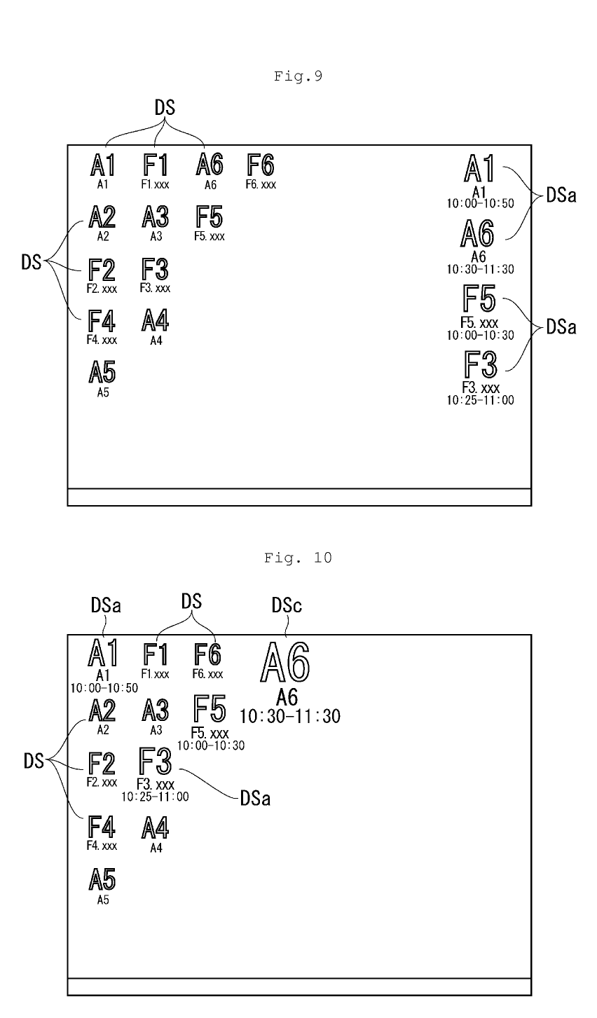

The display control unit 26 may display a display mode which has been changed, in a display mode other than that shown in FIG. 5. FIGS. 9, 10, and 11 are example screens of the display unit 14 displaying other changed display modes.

The display control unit 26 may display a display item DSa whose display mode has been changed in a predetermined area on the screen. For example, as shown in FIG. 9, the display control unit 26 may display the display item DSa whose display mode has been changed on the right side on the screen. The area where the display control unit 26 displays the display item whose display mode has been changed may be a gadget area.

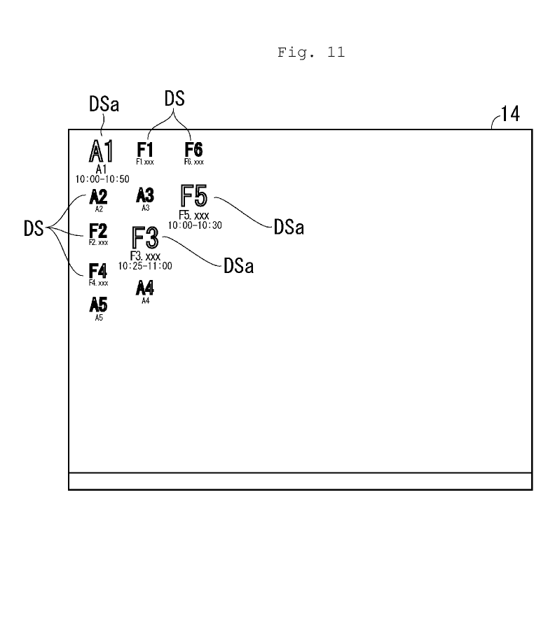

The display control unit 26 may change the display mode depending on the weight associated with each process. For example, as shown in FIG. 10, the display control unit 26 may display a display item DSc with a great weight in an enlarged manner, and display items DSa with small weights with sizes that are closer to the size of an unchanged display item DS due to the weights being smaller. Furthermore, the display control unit 26 may change the arrangements of the display items depending on the weights associated with respective processes. For example, the display control unit 26 may display a display item at an upper part of the screen if the weight is greater.

The display control unit 26 may display a display item DSa for activating a process that is estimated to be activated in an estimated time slot in a relatively highlighted manner by displaying display items DS other than the display item DSa for activating the process in a reduced manner as shown in FIG. 11.

The display control unit 26 may change the display mode by causing the display item to blink or by changing the color of the display item in the time slot, for example.

According to the embodiment described above, the estimation unit 24 estimates the time slot without distinguishing between holidays and other days, in the case where the pattern is “day”, but estimation may be performed while distinguishing between time slots of processes that are activated on holidays versus time slots of processes that are activated on other than holidays.

While the device 10 is activated, the display control unit 26 may change the display mode of a display item DS for a process for which the rate of time when the process is activated to the time when the device 10 is activated is equal to or greater than an activation threshold. The rate of time is 80%, for example. In this case, when the rate of activated time falls below the activation threshold, the display control unit 26 may return the display mode of the display item DS that has been changed to its original state.

The embodiment described above is an example in which the display control unit 26 returns the display item DS whose display mode has been changed to the original display mode when the time slot is over, but the changed display mode may be maintained after the time slot according to selection of the user. Additionally, the input unit 12 may acquire the selection of the user. Moreover, the embodiment described above is an example in which the display control unit 26 returns the display mode to its original display mode when the display item DS whose display mode has been changed is activated, but the change in the display mode may be maintained until the time slot is over. In this case, the display control unit 26 may perform the activities of block S62 between blocks S58 and S60 in FIG. 8.

The embodiment described above is an example in which the display control unit 26 changes and displays the name of the process by adding the time slot to the name of the display item DSa, but the time slot may alternatively be displayed above the display item DSa.

The embodiment described above is a case where the processing unit 20 stores in the storage unit 18 an entry, along with the start time and completion time of a schedule, as the schedule information. A process that is performed may be stored in association with that schedule information. Moreover, the estimation unit 24 may predict the schedule. For example, if there is an entry that is registered every week on the same day, the estimation unit 24 may predict registration of the entry every week on the same day, and may estimate the time slot of the process. Accordingly, even if the user forgets to register the schedule, the estimation unit 24 may estimate the time slot of the process.

The embodiment described above is an example in which the display control unit 26 changes the display mode for a display item whose time slot is reached, but the display of the entire screen including unchanged display items may be changed when a certain time slot is reached. Also in this case, the display control unit 26 changes only the display mode of a display item whose time slot is reached, without changing the display mode of a display item whose time slot is not reached. In other words, the display control unit 26 replaces the display of the entire screen from FIG. 5 or 9 to FIG. 11, for example. The display control unit 26 may realize the display described above as HTML (Hypertext Markup Language) display by the function of Active Desktop or the like.

The embodiment described above is an example in which the device 10 changes the display mode of the display item DS on the screen of the device 10, but the device 10 may also change the display mode of the display item DS on the screen of a computer different from the device 10.

In the embodiment described above, the estimation unit 24 calculates the weight by the equation “weight=number of times a process is activated+sum of performances”, but if the latest weight is stored in the time slot database 32, calculation may be performed based on “weight=latest weight+latest performance”. For example, in the case of A1.exe shown in FIG. 3, “W7=W4+1” is established. Additionally, the weight, the latest weight, and the latest performance may be the values for the same pattern.

In the embodiment described above, the estimation unit 24 registers, in the time slot database 32, a process whose weight is at or above the weight threshold, but a process to be registered in the time slot database 32 may be selected out according to another criterion. For example, in the case the pattern is “day”, the estimation unit 24 may perform selection based on an activation rate, which is the rate of the number of days a process is activated to the number of days the process is searched for. Additionally, “activation rate=(number of days a process is activated)/(number of days a process is searched for)” is established. For example, in the case the activation rate is 80% or more, the estimation unit 24 may register the process in the time slot database 32.

In the example of the time slot database 32 shown in FIG. 3, the estimation unit 24 sets the beginning and the end of the time slot with an interval of 30 minutes every hour, but this is not restrictive. For example, of the activation times of a selected process, the estimation unit 24 may estimate, as a time slot, a time before the first activation time by a time span set in advance to a time after the last activation time by the time span. The time span set in advance is 30 minutes, for example. In this case, for example, of the activation times of a selected application A1.exe, the estimation unit 24 estimates as a time slot 09:30 AM, which is 30 minutes (i.e., the time span) before 10 AM (which is the first activation time) to 10:58 AM (which is 30 minutes after the last activation time, 10:28 AM). In the same manner, when setting a time slot with respect to a schedule, the estimation unit 24 may set a time before the start time of the schedule by a time span to a time after the completion time by the time span as the time slot. The time span set in advance may be one hour, for example. Also, in some embodiments, the time span set in advance may be changed by the user.

The embodiment described above is an example in which the estimation unit 24 regularly estimates the time slot, but the time slot may be estimated irregularly, or regularly and irregularly. For example, the estimation unit 24 may estimate the time slot every time the schedule is changed. Further, the estimation unit 24 may estimate the time slot every time the schedule is changed, in addition to regularly estimating the time slot every day at the same time, for example.

The embodiment described above is an example in which the processing unit 20 stores an activation time in a process table in association with a process, and the collection unit 22 collects the process and the activation time to generate the record database 30, but the method of generating the record database 30 is not limited to this. For example, when a process is activated according to an input of a user, the processing unit 20 outputs the name of the activated process to the collection unit 22. The collection unit 22 thereby takes the time that the name of the process is received from the processing unit 20 as the activation time of the process, and registers the process and the activation time in the record database 30 in association with each other.

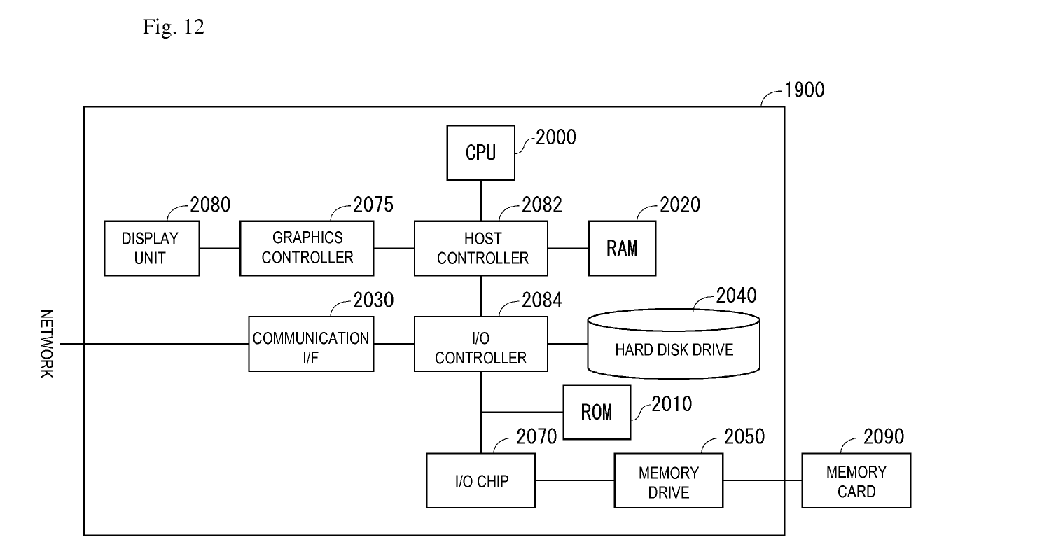

FIG. 12 shows an example of a hardware configuration of a computer 1900 according to the present embodiment. The computer 1900 according to the present embodiment is an example of the device 10. The computer 1900 includes a central processing unit (CPU) 2000, a RAM 2020, a graphics controller 2075, and a CPU peripheral unit including a display unit 2080 that are interconnected by a host controller 2082, a communication interface 2030 and an input/output unit including a hard disk drive 2040 that are connected to the host controller 2082 by the input/output controller 2084, and a legacy input/output unit including a ROM 2010, a memory drive 2050, and an input/output chip 2070 connected to the input/output controller 2084.

The host controller 2082 connects the RAM 2020 with the CPU 2000 and the graphics controller 2075 that access the RAM 2020 at a high transfer rate. The CPU 2000 operates based on programs stored in the ROM 2010 and the RAM 2020, and controls each unit. The graphics controller 2075 acquires image data generated by the CPU 2000 or the like on a frame buffer provided in the RAM 2020, and causes the same to be displayed on the display unit 2080. Alternatively, the graphics controller 2075 may include the frame buffer for storing image data generated by the CPU 2000 or the like.

The input/output controller 2084 connects the host controller 2082 to the communication interface 2030 and the hard disk drive 2040, which are relatively high-speed input/output devices. The communication interface 2030 communicates with other devices over a network. The hard disk drive 2040 stores programs such as display programs and data that are to be used by the CPU 2000 in the computer 1900.

Also, relatively low-speed input/output devices such as the ROM 2010, the memory drive 2050, and the input/output chip 2070 are connected to the input/output controller 2084. The ROM 2010 stores a boot program to be executed by the computer 1900 at the time of activation and/or programs dependent on the hardware of the computer 1900, and the like. The memory drive 2050 reads programs such as a display program and the like, or data from the memory card 2090, for example, and provides the same to the hard disk drive 2040 via the RAM 2020. The input/output chip 2070 connects the memory drive 2050 to the input/output controller 2084 and, also, connects various input/output devices to the input/output controller 2084 via a parallel port, a serial port, a keyboard port, a mouse port, and the like, for example.

Programs to be provided to the hard disk drive 2040 via the RAM 2020 are stored in a recording medium such as the memory card 2090 or an integrated circuit (IC) card, and are provided by the user. A program such as a display program is read from the recording medium, is installed on the hard disk drive 2040 in the computer 1900 via the RAM 2020, and is executed by the CPU 2000.

Programs installed on the computer 1900 to cause the computer 1900 to function as the device 10 include a processing module, a collection module, an estimation module, and a display control module. These programs or modules act on the CPU 2000 or the like, and cause the computer 1900 to function as the processing module, the collection module, the estimation module, and the display control module.

Information processing written in these programs is read by the computer 1900 to thereby function as the processing module, the collection module, the estimation module, and the display control module, which are concrete means achieved by software and various hardware resources described above collaborating with one another. Moreover, by performing operation or processing of information according to the intended use of the computer 1900 of the present embodiment by these concrete means, a unique device 10 according to the intended use is constructed.

For example, if communication is to be performed between the computer 1900 and an external device or the like, the CPU 2000 executes a communication program loaded in the RAM 2020 and, based on a process written in the communication program, instructs the communication interface 2030 to perform a communication process. Under the control of the CPU 2000, the communication interface 2030 reads transmission data stored in a transmission buffer area or the like provided in a storage device such as the RAM 2020, the hard disk drive 2040, or the memory card 2090 and transmits the data to a network, or writes reception data received from a network in a reception buffer area or the like provided in a storage device. In this manner, the communication interface 2030 may transfer transmission/reception data to/from a storage device by a DMA (direct memory access) method, or alternatively, the CPU 2000 may read data from a storage device or the communication interface 2030 that is the transfer source, and may transfer transmission/reception data by writing the data in the communication interface 2030 or a storage device which is the transmission destination.

Also, the CPU 2000 loads all or necessary files, databases, and the like stored in an external storage device such as the hard disk drive 2040, a memory drive 2050 (the memory card 2090), or the like into the RAM 2020 by DMA transfer or the like, and performs various processes on the data in the RAM 2020. Then, the CPU 2000 writes the processed data back into the external storage device by DMA transfer or the like. In such a process, the RAM 2020 is considered as a device for temporarily retaining the data stored in the external storage device, and thus, in the present embodiment, the RAM 2020, the external storage device, and the like are referred to collectively as a memory, a storage unit, a storage device, or the like. Various programs and various types of information such as data, tables, and databases of some embodiments are stored in such a storage device, and are made the targets of information processing. Additionally, the CPU 2000 may retain a part of the RAM 2020 in a cache memory, and perform reading and writing on the cache memory. Also in this mode, the cache memory serves a part of the function of the RAM 2020, and in the present embodiment, the cache memory is included in the RAM 2020, the memory and/or the storage device except for cases where distinction is necessary.

Furthermore, the CPU 2000 performs, on data read from the RAM 2020, various processes specified by command strings in a program including various operations, information processing, condition determination, retrieval/replacement of information, and the like described in the present embodiment, and writes the data back into the RAM 2020. For example, when performing condition determination, the CPU 2000 determines whether each of various variables in the present embodiment satisfies a condition such as being greater than, smaller than, equal to or greater than, equal to or smaller than, or equal to other variables or constants, and if the condition is satisfied (or unsatisfied), branching to a different command string is performed or a sub-routine is called. Furthermore, the CPU 2000 may retrieve information stored in a file, a database, or the like in a storage device.

The program or modules mentioned above may be stored in an external recording medium. As such a recording medium, an optical recording medium such as a DVD or a CD, a magneto-optical recording medium such as an MO (magneto-optical drive), a tape medium, a semiconductor memory such as an IC card, and the like may be used, in addition to the memory card 2090. Also, the program may be provided to the computer 1900 via a network by using, as a recording medium, a storage device such as a RAM or a hard disk provided in a server system connected to a dedicated communication network or the Internet.

Embodiments of this disclosure have been described above, but the technical scope of the disclosure is not limited to the scope of the embodiments described above. As is clear to those skilled in the art, various changes or modifications may be made to the embodiments described above. Furthermore, as is clear from the scope of claims, embodiments resulting from such changes or modifications are also within the technical scope of this disclosure.

It should be noted that the execution order of processes of operations, procedure, steps, phases, and the like of the device, system, program, and method described in the scope of claims, specification, and drawings is arbitrary if there is no clear specification by “before”, “preceding” or the like, and if the output of a preceding process is not used by a following process. In describing the operation flow of the scope of claims, specification and drawings, “first”, “next”, and the like may be used for the sake of convenience, but this does not means that operation in this order is mandatory.

1. A device comprising:
a collection unit configured to collect a record of a process operated on a computer by a user;
an estimation unit configured to estimate a time slot when the process is to be activated, based on the collected record; and
a display control unit configured to change, by a computer processor, a display mode of a display item for activating the process according to the estimated time slot, on a screen of the computer.

2. The device according to claim 1, wherein the display control unit is configured to change the display mode of the display item by displaying the display item in a highlighted manner.

3. The device according to claim 1, wherein if the display item is not displayed on the screen, the display control unit displays a shortcut for the process on the screen in the time slot.

4. The device according to claim 1, wherein the display control unit modifies the display mode of the display item that has been changed to return the process to an original display mode based on activation of the process by the user.

5. The device according to claim 1, further comprising:
a schedule storage unit for storing schedule information of the user,
wherein the estimation unit is configured to estimate, according to an entry of each schedule included in the schedule information and a start time and a completion time of the schedule, the time slot of the process used for the schedule.

6. The device according to claim 5, wherein the collection unit is configured to associate the process with the schedule information.

7. The device according to claim 5, wherein the estimation unit is configured to determine whether the schedules are the same, based on the entry.

8. The device according to claim 1, wherein the estimation unit is configured to estimate one or more time slots while distinguishing between the time slot of the process being is activated on a holiday and the time slot of the process being is activated on other than the holiday.

9. The device according to claim 1, wherein the display control unit is configured to change the display mode of the display item while the computer is activated, for the process for which a rate of time when the process is activated while the computer is activated is equal to or greater than a threshold.

10. The device according to claim 1, wherein the display control unit maintains in a changed display mode after the time slot the display item whose display mode is changed in the estimated time slot, based on a selection of the user.

11. The device according to claim 1, wherein the display control unit is configured to display in a predetermined area on the screen the display item whose display mode is changed.

12. The device according to claim 1, wherein the display control unit is configured to display the display item for activating the process in a relatively highlighted manner by displaying, in a reduced manner, the display item other than the display item for the process that is estimated to be activated in the estimated time slot.

13. The device according to claim 1, wherein the display control unit is configured to display information indicating the estimated time slot in association with the display item.

14. The device according to claim 1, wherein the display control unit is configured to change a name of the process included in the display item.

15. The device according to claim 1, wherein the estimation unit is configured to estimate the time slot according only to the process activated by the user.

16. The device according to claim 1, wherein the estimation unit is configured to regularly estimate the time slot.

17. A computer-implemented method comprising:
collecting a record of a process operated on a computer by a user;
estimating a time slot when the process is to be activated, based on the collected record; and
changing a display mode of a display item for activating the process according to the estimated time slot, on a screen of the computer.

18. The method of claim 17, wherein changing the display mode of the display item comprises displaying the display item in a highlighted manner.

19. A computer program product for displaying a schedule item, the computer program product comprising a computer readable storage medium having program instructions embodied therewith, the program instructions executable by a processor to cause the processor to perform a method comprising:
collecting a record of a process operated on a computer by a user;
estimating a time slot when the process is to be activated, based on the collected record; and
changing, by a computer processor, a display mode of a display item for activating the process according to the estimated time slot, on a screen of the computer.

20. The computer program product of claim 1, wherein changing the display mode of the display item comprises displaying the display item in a highlighted manner.
